(19) United States
(12) Patent Application Publication
(10) Pub. No.: US 2008/0190451 A1
(43) Pub. Date: Aug. 14, 2008

(54) SEMICONDUCTOR MANUFACTURING APPARATUS AND METHOD FOR MANUFACTURING SEMICONDUCTOR DEVICE

(75) Inventor: Masanori Goto, Kanagawa (JP)

Correspondence Address: Young & Thompson, Second Floor, 745 S. 23rd Street., Arlington, VA, 22202, US

(73) Assignee: NEC ELECTRONICS CORPORATION, Kawasaki (JP)

(21) Appl. No.: 12/028,225

(22) Filed: Feb. 8, 2008

(30) Foreign Application Priority Data
Feb. 8, 2007 (JP) 2007-029787

(51) Int. Cl. B08B 1/04; A46B 13/02

(52) U.S. Cl. 134/6; 15/77

(57) ABSTRACT

A semiconductor device manufacturing apparatus includes a first supporting unit; a first brush configured to brush and clean a substrate fixed to the first supporting unit; a second supporting unit; and a second brush configured to brush and clean the substrate fixed to the second supporting unit. The first supporting unit rotates in a state that the wafer is fixed to the first supporting unit. The second supporting unit comprises a roller configured to contact a peripheral portion of the wafer and to rotate the wafer, and the first supporting unit and the second supporting unit approach to and separate from each other.

### BACKGROUND OF THE INVENTION

1. Field of the Invention

The present invention relates to a semiconductor manufacturing apparatus and a method of manufacturing a semiconductor device, and especially relates to a semiconductor manufacturing apparatus for a wafer cleaning process and a method of manufacturing a semiconductor device through a wafer cleaning process. This patent application is based on Japanese patent application No. 2007-029787. The disclosure thereof is incorporated herein by reference.

2. Description of Related Art

A wafer is cleaned to remove particles attaching to the wafer and contaminants such as organic substances or metallic impurities, every time processing is completed in respective steps of a semiconductor manufacturing process.

Japanese Patent Application Publication (JP-P2003-007662A, first conventional example) discloses a substrate cleaning apparatus. The substrate cleaning apparatus includes an upper cleaning unit and a lower cleaning unit which are laid in a double-decker shape; and a conveying robot for conveying a substrate between both of the cleaning units. The upper cleaning unit includes a first substrate supporting mechanism for supporting the substrate; an upper roll sponge for cleaning an upper surface of the substrate; and a lower roll sponge for cleaning a lower surface of the substrate. The first substrate supporting mechanism includes a plurality of chuck rollers, which are arranged on a periphery of the substrate at even intervals. The chuck rollers move in a direction of a radius of the substrate and hold the substrate between them. The substrate is rotated through rotation of the chuck rollers. The lower cleaning unit includes a second substrate supporting mechanism for supporting the substrate and a pencil-type pencil sponge for cleaning the upper surface of the substrate. The second substrate supporting mechanism includes a wafer chuck wheel having a plurality of clicks on the periphery of the wafer. A plurality of the clicks sandwiches the peripheral part on the substrate. The wafer chuck wheel is rotated by a motor. The conveying robot is provided in adjacent to the both cleaning units. The conveying robot can carry the substrate in and out of the upper cleaning unit and the lower cleaning unit and move the substrate in the horizontal direction, and can move the substrate upward and downward.

Cleaning of the substrate by the above mentioned substrate cleaning apparatus will be described. The conveying robot carries the substrate received from a unit for a previous step into the upper cleaning unit and transfers the substrate to the first substrate supporting mechanism. The upper cleaning unit cleans the upper surface and lower surface of the substrate while rotating the substrate by the chuck rollers. After the cleaning is completed, the conveying robot receives the substrate from the first substrate supporting mechanism, carries the substrate out of the upper cleaning unit, and lowers the substrate to the height of the lower cleaning unit. The conveying robot carries the substrate to the lower cleaning unit and transfers the substrate to the second substrate supporting mechanism. The lower cleaning unit cleans the substrate by making the pencil sponge contact to the upper surface while rotating the substrate at a low speed by using the wafer chuck wheel. After the cleaning is completed, the lower cleaning unit removes cleaning fluid attached to the substrate by using centrifugal force through rotation of the wafer chuck wheel at high speed to dry the substrate. After the drying is completed, the conveying robot receives the substrate from the second substrate supporting mechanism, carries the substrate out of the lower cleaning unit, and stores the substrate in a cassette.

In the above-described substrate cleaning apparatus, an installation area of the whole of the substrate cleaning apparatus including the conveying robot is large, since the conveying robot is provided in adjacent to both the cleaning units. In addition, since the substrate is carried in the lower cleaning unit after carried out of the upper cleaning unit once, it seems more likely that the substrate is contaminated and it takes long time to convey the substrate. Furthermore, since a multi-jointed robot having a plurality of joint parts is used, the movable parts of the conveying robot are likely to fail.

### SUMMARY

In an aspect of the present invention, a semiconductor device manufacturing apparatus includes a first supporting unit; a first brush configured to brush and clean a substrate fixed to the first supporting unit; a second supporting unit; and a second brush configured to brush and clean the substrate fixed to the second supporting unit. The first supporting unit rotates in a state that the wafer is fixed to the first supporting unit. The second supporting unit comprises a roller configured to contact a peripheral portion of the wafer and to rotate the wafer, and the first supporting unit and the second supporting unit approach to and separate from each other.

In another aspect of the present invention, there is provided a method of manufacturing a semiconductor device by a manufacturing apparatus which comprises: a first supporting unit configured to rotate in a state that a substrate is fixed; and a second supporting unit comprising a roller configured to contact a peripheral portion of the wafer and to rotate the wafer. The method includes brushing and cleaning the wafer supported by the second supporting unit; making the first supporting unit and the second supporting unit approach; and transferring the wafer from the second supporting unit to the first supporting unit.

According to the present invention, a semiconductor device manufacturing apparatus and a method of manufacturing a semiconductor device are provided which can pass a wafer directly from one supporting unit for rotating the wafer to another supporting unit for rotating the wafer.

### BRIEF DESCRIPTION OF THE DRAWINGS

The above and other objects, advantages and features of the present invention will be more apparent from the following description of embodiments taken in conjunction with the accompanying drawings, in which:

FIG. 1 is a side view showing a semiconductor manufacturing apparatus according to a first embodiment of the present invention;

FIG. 2 is a side view showing an operation in passing a wafer in the semiconductor manufacturing apparatus according to the first embodiment;

FIG. 3 is an upper view showing a first supporting apparatus and a second supporting apparatus of the semiconductor manufacturing apparatus according to the first embodiment;

FIG. 4 is an upper view showing an operation in passing a wafer in the first supporting apparatus and the second supporting apparatus;

FIG. 5 is an upper view showing a first supporting apparatus and an upper brush of the semiconductor manufacturing apparatus according to a second embodiment of the present invention; and

FIG. 6 is a side view showing an operation in passing a wafer of a lower brush in the semiconductor manufacturing apparatus according to the second embodiment.

### DESCRIPTION OF THE PREFERRED EMBODIMENTS

Hereinafter, a semiconductor manufacturing apparatus and a method for manufacturing a semiconductor device according to embodiments of the present invention will be described with reference to the attached drawings. In the drawings, directions of X, Y, and Z are shown which are perpendicular to each other The Z direction, for example, is a vertical direction. The X and Y directions, for example, are horizontal directions which are perpendicular to each other.

### First Embodiment

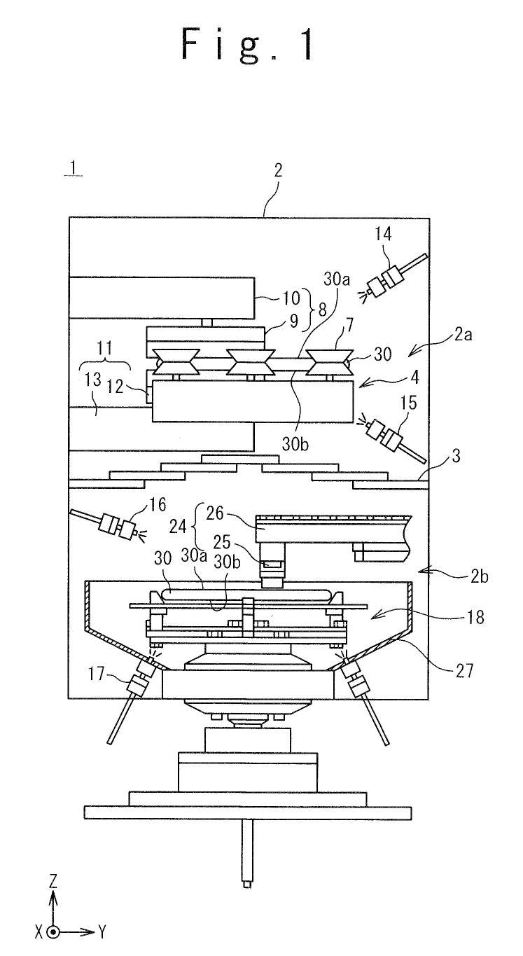

FIG. 1 is a side view of a semiconductor manufacturing apparatus 1 according to a first embodiment of the present invention. The semiconductor manufacturing apparatus 1 includes a chamber 2, a shutter 3, a substrate supporting unit 4 for cleaning both surfaces of a substrate (a semiconductor wafer), an upper brush 8, a lower brush 11, nozzles 14 to 17, a substrate supporting unit 18 for cleaning one surface of the wafer, a brush 24, and a cover 27.

The shutter 3 is provided to divide the chamber 2 into an upper side 2a and a lower side 2b, and can be opened and closed. The upper side 2a is arranged on an upper side of the Z direction and the lower side 2b is arranged on a lower side of the Z direction. After cleaning both surfaces of the wafer 30 received from a previous stage in the upper side 2a, the semiconductor manufacturing apparatus 1 cleans one surface of the wafer 30 in the lower side 2b, dries the wafer 30, and transfers the wafer to a next stage.

The substrate supporting unit 4, the upper brush 8, the lower brush 11, and the nozzles 14 and 15 are arranged on the upper side 2a. The substrate supporting unit 4 includes a plurality of rollers 7. The plurality of rollers 7 supports the wafer 30 by contacting a peripheral portion of the wafer 30. The wafer 30 has a shape of a circular disk and includes a front surface 30a and a rear surface 30b on both sides as surfaces of the circular disk. Each of the plurality of rollers 7 can rotate around a rotation axis parallel with the Z direction. When at least one of the plurality of rollers 7 is rotated by a driving unit (not shown), the wafer 30 rotates around the rotation axis which passes a center of the wafer 30 and is parallel with the Z direction. The substrate supporting unit 4 is also called a roller chuck. Here, the front surface 30a faces upward and the rear surface 30b faces the lower substrate supporting unit 18. A scrub cleaning is performed on the front surface 30a by the upper brush 8 while spraying cleaning fluid to the surface 30a from the nozzle 14 and rotating the wafer 30 by the roller 7. The upper brush 8 includes a body of brush 9, and an arm 10 for supporting the brush body 9 rotatably around a brush rotation axis parallel with the Z direction. In the brush body 9, hairs are transplanted on a surface of the circular disk perpendicular to the rotation axis of the brush. The scrub cleaning is performed on the rear surface 30b by the lower brush 11 while spraying cleaning fluid to the rear surface 30b from the nozzle 15 and rotating the wafer 30 by the roller 7. The lower brush 11 includes a brush body 12, and an arm 13 for supporting the brush body 12 rotatably around the brush rotation axis parallel with the Z direction. In the brush body 12, hairs are transplanted on a surface of the circular disk perpendicular to the rotation axis of the brush.

The nozzle 16, the nozzle 17, the substrate supporting unit 18, the brush 24 and the cover 27 are arranged on the lower side 2b. The substrate supporting unit 18 can rotate around a rotation axis of the supporting unit parallel with the Z direction in a state that the wafer 30 is fixed so that the surface 30a faces upward. The substrate supporting unit 18 is also called a mechanical chuck. This rotation axis of the supporting unit passes a center of the wafer 30. This rotation axis of the supporting unit and the rotation axis of the wafer 30 when the wafer 30 is rotated by the rollers 7 are arranged on a same line. The scrub cleaning is performed on the front surface 30a by the brush 24 while spraying cleaning fluid to the rear surface 30a from the nozzle 16 and to the rear surface 30b from the nozzle 17, and rotating the substrate supporting unit 18 at a relatively low speed. The brush 24 includes a pencil type brush body 25, an arm 26 for supporting the brush body 25 rotatably around the rotation axis of the brush parallel with the Z direction. The brush 24 is also called a pencil brush. The cover 27 covers circumference of the substrate supporting unit 18 when the wafer 30 is cleaned by using the brush 24. After the cleaning is completed, cleaning fluid attached to the wafer 30 is removed by centrifugal force while rotating the substrate supporting unit 18 at a relatively high speed to dry the wafer 30.

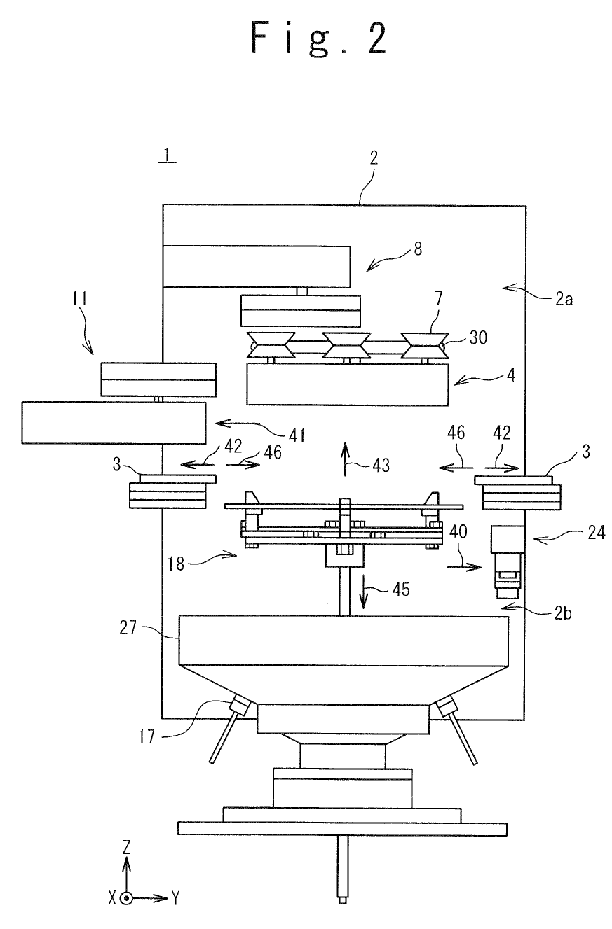

Referring to FIGS. 2 to 4, an operation of the semiconductor manufacturing apparatus 1 when the wafer 30 whose both surfaces have been cleaned in the upper side 2a is transferred from the substrate supporting unit 4 to the substrate supporting unit 18.

Referring to FIG. 2, as shown by an arrow 40, the brush 24 is first evacuated from a space between the wafer 30 supported by the substrate supporting unit 4 and the substrate supporting unit 18 along the Y direction. Subsequently, as shown by an arrow 41, the lower brush 11 is evacuated from a space between the wafer 30 supported by the substrate supporting unit 4 and the substrate supporting unit 18 along the Y direction. Subsequently, as shown by an arrow 42, the upper side 2a and the lower side 2b are connected by opening the shutter 3. Subsequently, as shown by an arrow 43, the substrate supporting unit 18 is made to approximate the substrate supporting unit 4 along the Z direction.

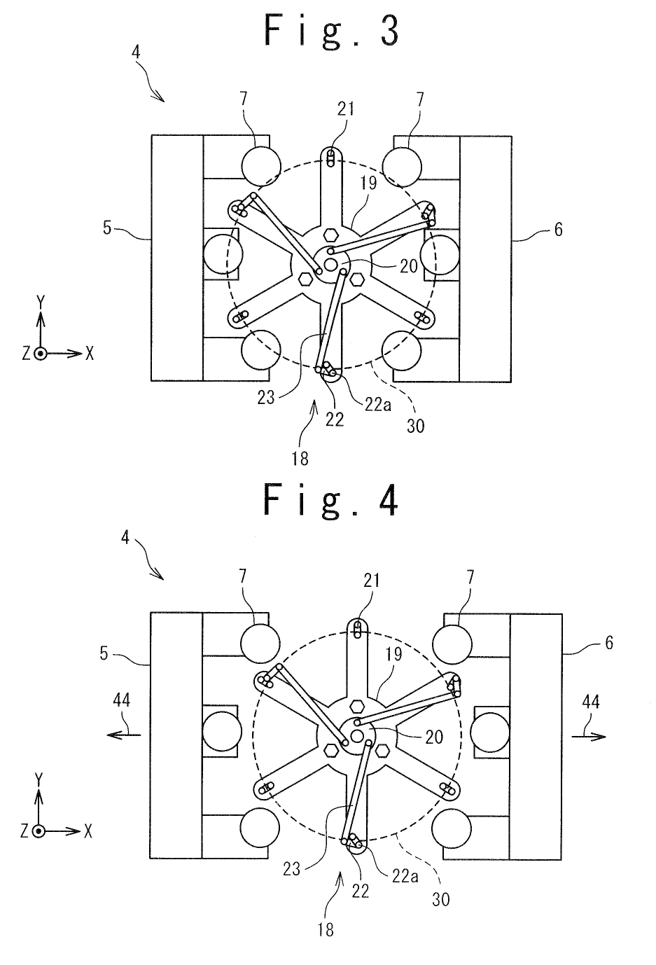

FIG. 3 is an upper view of the substrate supporting unit 4 and the substrate supporting unit 18 when the substrate supporting unit 18 approximates the substrate supporting unit 4. The substrate supporting unit 4 includes a roller pedestal 5 and a roller pedestal 6. To each of the roller pedestal 5 and the roller pedestal 6, the plurality of rollers 7 are attached to rotate around the rotation axis of the roller parallel with the Z direction. The substrate supporting unit 4 supports the wafer 30 in a condition that the plurality of rollers 7 provided by the roller pedestal 5 and the roller pedestal 6 contact the peripheral portions of the wafer 30. The roller pedestal 5 and the roller pedestal 6 can be approximated and separated from each other along the X direction. Meanwhile, the substrate supporting unit 18 includes a rotation body 19, a rotation body 20, a plurality of fixed supporters 21, a plurality of movable supporters 22, and links 23. The rotation body 19 can rotate around the rotation axis of the supporting unit parallel with the Z direction. The rotation body 20 is supported by the rotation body 19 to rotate around the rotation axis of the supporting unit against the rotation body 19. Each of the plurality of fixed supporters 21 is fixed to the rotation body 19. Each of the plurality of movable supporters 22 is supported by the rotation body 19 to rotate around the rotation axis of the movable supporter parallel with the rotation axis of the supporting unit against the rotation body 19, and includes a contacting part 22a provided on a position which is not aligned with the rotation axis of the movable supporter. Each of the links 23 is provided for one of the plurality of movable supporters 22, and connects each of the plurality of movable supporters 22 with the rotation body 20. The contacting part 22a is arranged on a circumference made by employing the rotation axis of the supporting unit as a central axis. The link 23 rotates each of the plurality of movable supporters 22 against the rotation body 19 so that a radius of the circumference on which the contacting part 22a is arranged can be reduced and increased in accordance with forward and reverse rotations of the rotation body 20 against the rotation body 19.

Referring to FIG. 4, as shown by an arrow 44, the wafer 30 is released from the substrate supporting unit 4 by separating the roller pedestal 5 and the roller pedestal 6 along the X direction. The released wafer 30 is supported by the plurality of fixed supporters 21. Subsequently, the rotation body 20 rotates against the rotation body 19, the contacting part 22a contacts the peripheral part of the wafer 30 by reducing the radius of the circumference on which the contacting part 22a is arranged, and the wafer 30 is fixed to the substrate supporting unit 18.

Referring to FIG. 2, as shown by an arrow 45, the substrate supporting unit 18 to which the wafer 30 is fixed is separated from the substrate supporting unit 4 along the Z direction and arranged on the lower side 2b. Subsequently, as shown by an arrow 46, the upper side 2a and the lower side 2b are isolated by closing the shutter 3. After that, the wafer 30 is cleaned with using the brush 24.

In the present embodiment, since the wafer 30 is transferred directly from the substrate supporting unit 4 to the substrate supporting unit 18, a required time for transferring the wafer can be short. In addition, a robot for conveying the wafer 30 from the substrate supporting unit 4 to the substrate supporting unit 18 is riot be required. For this reason, an installation space for the conveying robot is not required. In addition, the wafer 30 can be prevented from being contaminated since the wafer 30 is not carried out of the chamber 2 when the wafer 30 is transferred.

In the present embodiment, the semiconductor manufacturing apparatus 1 can be realized in a simple structure since the substrate supporting unit 4 and the substrate supporting unit 18 are approximated and separated by moving the substrate supporting unit 18. Although the structure is complicated slightly, the substrate supporting unit 4 and the substrate supporting unit 18 may be approximated and separated by moving the substrate supporting unit 4. Even in this case, the wafer 30 is transferred directly from the substrate supporting unit 4 to the substrate supporting unit 18. Furthermore, in the present embodiment, the rotating movement of the rotation body 20 for fixing and releasing the wafer 30 by the substrate supporting unit 18 against the rotation body 19 and the rotating movement of the whole of the substrate supporting unit 18 for cleaning and drying the wafer 30 are performed around a common rotation axis of the supporting unit, and the substrate supporting unit 18 is moved along this rotation axis of the supporting unit. For this reason, the substrate supporting unit 18 can be manufactured easily.

In the present embodiment, the substrate supporting unit 4 can be realized in a simple structure since the wafer 30 is supported and released by approximating and separating the roller pedestal 5 and the roller pedestal 6 to which the plurality of rollers 7 is attached. Although the structure of the substrate supporting unit 4 is complicated slightly, the wafer 30 may be supported and released by moving each of the plurality of rollers 7 in the radius direction of the wafer 30.

In the present embodiment, during the cleaning of one wafer 30 in the lower side 2b, another wafer 30 can be cleaned in the upper side 2a since the chamber 2 is divided by closing the shutter 3.

### Second Embodiment

The semiconductor manufacturing apparatus 1′ according to a second embodiment of the present invention will be described below. Similar to the semiconductor manufacturing apparatus 1, the semiconductor manufacturing apparatus 1′ includes the chamber 2, the shutter 3, the substrate supporting unit 4, the nozzles 14 to 17, the substrate supporting unit 18, the brush 24, and the cover 27. These configurations and operations are same as those of the semiconductor manufacturing apparatus 1.

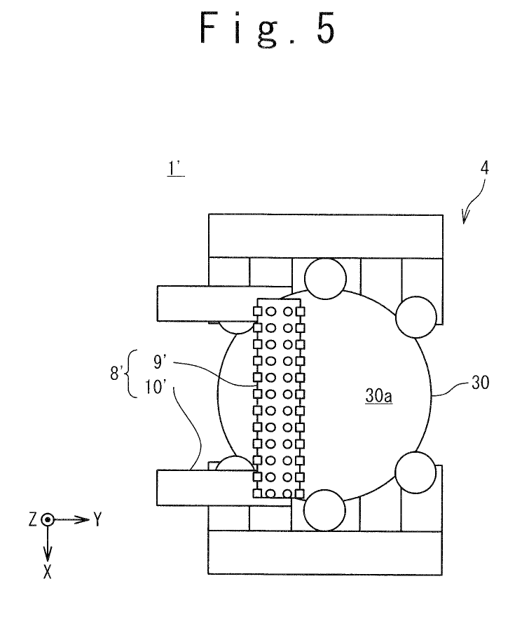

As shown in FIG. 5, the semiconductor manufacturing apparatus 1′ includes an upper brush 8′ instead of the upper brush 8. The upper brush 8′ is used for performing the scrub cleaning for the front surface 30a of the wafer 30 supported by the substrate supporting unit 4. The upper brush 8′ includes a brush body 9′, and an arm 10′ for supporting the brush body 9′ rotatably around the rotation axis of the brush parallel with the X direction. In the brush body 9′, hairs are transplanted on a surface of a circular disk perpendicular to the rotation axis of the brush.

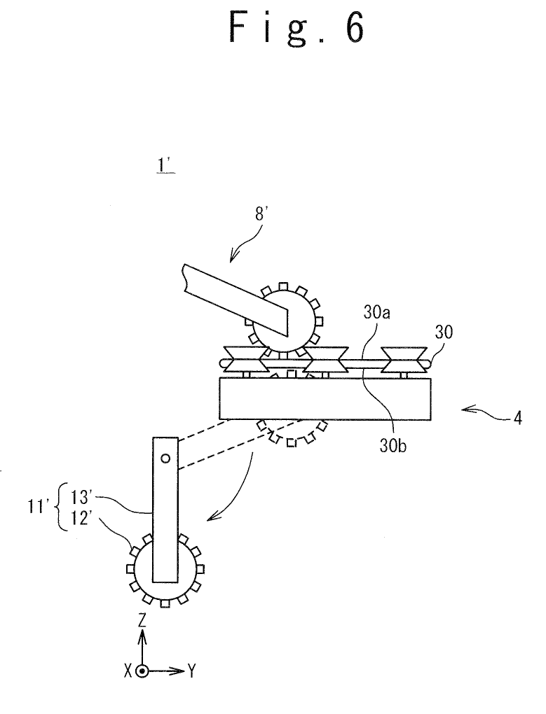

As shown in FIG. 6, the semiconductor manufacturing apparatus 1′ includes a lower brush 11′ instead of the lower brush 11. The lower brush 11′ is used for performing the scrub cleaning for the rear surface 30b of the wafer 30 supported by the substrate supporting unit 4. The lower brush 11′ includes a brush body 12′, and an arm 13′ for supporting the brush body 12′ rotatably around the rotation axis of the brush parallel with the X direction. In the brush body 12′, hairs are transplanted on a surface of a circular disk perpendicular to the rotation axis of the brush The arm 13′ is supported against the chamber 2 to oscillate around an oscillating axis parallel with the X direction. In the semiconductor manufacturing apparatus 1′, when the wafer 30 is transferred from the substrate supporting unit 4 to the substrate supporting unit 18, the lower brush 11′ is evacuated from a space between the wafer 30 supported by the substrate supporting unit 4 and the substrate supporting unit 18 by oscillating the lower brush 11′ from a cleaning position shown by a broken line to an evacuating position shown by a solid line in FIG. 6.

In the present embodiment, an installation area of the semiconductor manufacturing apparatus 1′ can be made small since the lower brush 11′ is evacuated by being oscillated around the horizontal oscillating axis without being evacuated along the horizontal direction.

Although the present invention has been described above in connection with several embodiments thereof, it will be appreciated by those skilled in the art that those embodiments are provided solely for illustrating the present invention, and should not be relied upon to construe the appended claims in a limiting sense.

What is claimed is:

1. A semiconductor device manufacturing apparatus comprising:
a first supporting unit;
a first brush configured to brush and clean a substrate fixed to said first supporting unit;
a second supporting unit; and
a second brush configured to brush and clean said substrate fixed to said second supporting unit,
wherein said first supporting unit rotates in a state that said wafer is fixed to said first supporting unit,
said second supporting unit comprises a roller configured to contact a peripheral portion of said wafer and to rotate said wafer, and
said first supporting unit and said second supporting unit approach to and separate from each other.

2. The semiconductor device manufacturing apparatus according to claim 1, wherein said first supporting unit rotates around a first axis, and said first supporting unit and said second supporting unit approach to and separate from each other in a direction of said first axis.

3. The semiconductor device manufacturing apparatus according to claim 2, wherein said second supporting unit comprises a first roller pedestal to which a first roller group containing said roller is attached, and a second roller pedestal to which a second roller group is attached,
each of rollers of said first roller group and said second roller group rotates around a roller rotation axis which is parallel to said first axis, and
said first roller pedestal and said second roller pedestal approach to and separate from each other in a direction perpendicular to said first axis.

4. The semiconductor device manufacturing apparatus according to claim 2, wherein said first supporting unit comprises:
a first rotation body configured to rotate around said first axis;
a second rotation body supported by said first rotation body so as to be rotatable around said first axis to said first rotation body;
a plurality of movable supporters; and
links configured to connect said plurality of movable supporters and said second rotation body,
wherein each of said plurality of movable supporters is supported by said first rotation body so as to be rotatable around s movable supporter rotation axis parallel to said first axis to said first rotation body, and has a contact portion which contacts the peripheral portion of said wafer is provided apart from said movable supporter rotation axis,
said contact portion is arranged on a circumference having said first axis as a center axis,
said links moves said plurality of movable supporters such that a radius of said circumference is increased or decreased based on the rotation and a reverse rotation of said second rotation body to said first rotation body, and
said first supporting unit moves along said first axis.

5. The semiconductor device manufacturing apparatus according to claim 2, wherein said second brush comprises a brush body configured to brush a surface of said wafer supported by said second supporting unit, said wafer surface facing said first supporting unit, and an arm configured to support said brush body,
said arm oscillates around an oscillation axis perpendicular to said first axis,
a direction of said first axis is a vertical direction.

6. The semiconductor device manufacturing apparatus according to claim 1., further comprising:
a chamber; and
a shutter configured to partition said chamber into a first chamber and a second chamber,
wherein when said first brush brushes said wafer, said first supporting unit and said first brush are located on a side of said first chamber, and
when said second brush brushes said wafer, said second supporting unit and said second brush are located on a side of said second chamber.

7. A method of manufacturing a semiconductor device by a manufacturing apparatus which comprises:
a first supporting unit configured to rotate in a state that a substrate is fixed; and
a second supporting unit comprising a roller configured to contact a peripheral portion of said wafer and to rotate said wafer,
said method comprising:
brushing and cleaning said wafer supported by said second supporting unit;
making said first supporting unit and said second supporting unit approach; and
transferring said wafer from said second supporting unit to said first supporting unit.

8. The method according to claim 7, wherein said first supporting unit rotates around a first axis,
said making said first supporting unit and said second supporting unit approach comprises:
making said first supporting unit and said second supporting unit approach along the first axis.

9. The method according to claim 8, wherein said second supporting unit comprises:
a first roller pedestal to which a first roller group containing said roller is attached; and
a second roller pedestal to which a second roller group is attached,
wherein each of rollers which are contained in said first roller group and said second roller group rotates around a roller rotation axis parallel to said first axis,
said transferring comprises:
separating said first roller pedestal and said second roller pedestal from each other along a direction perpendicular to said first axis to release said wafer.

10. The method according to claim 8, wherein said first supporting unit comprises:
a first rotation body configured to rotate around said first axis;
a second rotation body supported by said first rotation body so as to be rotatable around said first axis to said first rotation body;
a plurality of movable supporters; and
links configured to connect said plurality of movable supporters and said second rotation body,
wherein each of said plurality of movable supporters is supported by said first rotation body so as to be rotatable around s movable supporter rotation axis parallel to said first axis to said first rotation body, and has a contact portion which contacts the peripheral portion of said wafer is provided apart from said movable supporter rotation axis,
said contact portion is arranged on a circumference having said first axis as a center axis,
said links moves said plurality of movable supporters such that a radius of said circumference is increased or decreased based on the rotation and a reverse rotation of said second rotation body to said first rotation body, and
said method further comprises:
making said contact portion to contact the peripheral portion of said wafer by rotating said second rotation body to said first rotation body, such that said wafer is fixed to said first supporting unit, and
said making said first supporting unit and said second supporting unit approach comprises:
making said first supporting unit to approach along the first axis.

11. The method according to claim 8, wherein said second brush comprises a brush body configured to brush a surface of said wafer supported by said second supporting unit, said wafer surface facing said first supporting unit, and an arm configured to support said brush body,
said arm oscillates around an oscillation axis perpendicular to said first axis,
a direction of said first axis is a vertical direction,
said method further comprises:
making said arm to oscillate around an oscillation axis perpendicular to said first axis such that said brush body and said arm are saved from a space between said first supporting unit and said wafer supported by said second supporting unit.

12. The method according to claim 7, wherein said semiconductor device manufacturing apparatus comprises:
a chamber; and
a shutter configured to partition said chamber into a first chamber and a second chamber,
said method further comprises:
separating said first supporting unit and said second supporting unit from each other; and
brushing and cleaning said wafer supported by said first supporting unit,
said washing and cleaning said wafer supported by said second supporting unit comprises:
positioning said second supporting unit in said second chamber, and
said washing and cleaning said wafer supported by said first supporting unit comprises:
positioning said second supporting unit in said first chamber.
